(19) United States
(12) Patent Application Publication
(10) Pub. No.: US 2005/0023425 A1
(43) Pub. Date: Feb. 3, 2005

(54) Elevator hoistway support bracket

(76) Inventor: Edward W. Jackson, Garland, TX (US)

Correspondence Address: GARDERE WYNNE SEWELL LLP;INTELLECTUAL PROPERTY SECTION, 3000 THANKSGIVING TOWER, 1601 ELM ST, DALLAS, TX, 75201-4761, US

(21) Appl. No.: 10/629,974

(22) Filed: Jul. 30, 2003

(51) Int. Cl. F16B 45/00

(52) U.S. Cl. 248/304

(57) ABSTRACT

A support bracket for mounting on a support rail for elevator doors disposed at a doorway between a floor of a building and an elevator hoistway. The support bracket includes a transverse frame member and plural spaced apart hook members engagable with the door support rail. A depending member connected to the frame member supports hoisting equipment, such as a block and tackle. Retaining screws are mounted on the hook members and are engagable with the support rail when the support bracket is in a working position to aid in retaining the hook members engaged with the support rail. The support bracket may be mounted on and demounted from the door support rail by one or more persons standing at the doorway.

### BACKGROUND OF THE INVENTION

In the art of elevator construction, service and repair, it is often necessary to raise and lower equipment, persons and materials within the elevator shaft or hoist-way. In this regard, it has often been necessary to use ladders extending between an elevator door opening at a lower floor and the pit of the hoistway, if possible, or it has been necessary to use very heavy and cumbersome equipment extending through an open doorway into the elevator shaft or hoistway for use in raising and lowering equipment, material and persons to the point within the elevator shaft at which work is to be carried out. These prior art methods of working with equipment and material in elevator shafts or hoistways are somewhat hazardous and inefficient.

Accordingly, there has been a strongly felt need for improvements associated with elevator service and repair work which requires the movement of material, equipment or persons in and out of an elevator shaft or hoistway. It is to these ends that the present invention has been developed.

### SUMMARY OF THE INVENTION

The present invention provides a support member or bracket for mounting in a doorway of an elevator shaft or hoistway and for supporting hoisting equipment during service, repair or construction of an elevator system.

In accordance with an important aspect of the present invention a support bracket is provided which may be mounted on support structure for elevator doors at an elevator doorway, the support bracket being adapted for supporting hoisting equipment, such as a block and tackle apparatus for use in gaining access to an elevator hoistway, including the bottom or pit portion thereof. The support bracket is particularly adapted for mounting on a support and guide rail for doors which close over an elevator opening at a particular floor or level within a building in which the elevator hoistway is disposed. The support bracket is easily mounted on the door support structure or rail from the floor or level at which the door opening is provided and the bracket is easily removed through the opening when the service or repair work is completed. Still further, the support bracket is provided with means for securing the support bracket to the elevator door support structure or rail to minimize the chance of the support bracket inadvertently becoming disconnected from the door support structure or rail.

The support bracket of the present invention overcomes the inefficiencies of prior art practice in performing service or repair work which requires access to an elevator shaft or hoistway.

Those skilled in the art will further appreciate the advantages and superior features of the invention upon reading the detailed description which follows in conjunction with the drawings.

### BRIEF DESCRIPTION OF THE DRAWING

FIG. 1 is perspective view of an elevator shaft or hoistway showing the support bracket of the invention mounted in its working position and supported by an elevator door support and guide rail;

FIG. 2 is a detail section view taken generally from the line 2-2 of FIG. 1; and

FIG. 3 is a view taken generally from the line 3-3 of FIG. 2.

### DETAILED DESCRIPTION OF A PREFERRED EMBODIMENT

In the description which follows like parts are marked throughout the specification and drawing with the same reference numbers, respectively. The drawing figures are not necessarily to scale and certain elements may be shown in somewhat exaggerated or schematic form in the interest of clarity and conciseness.

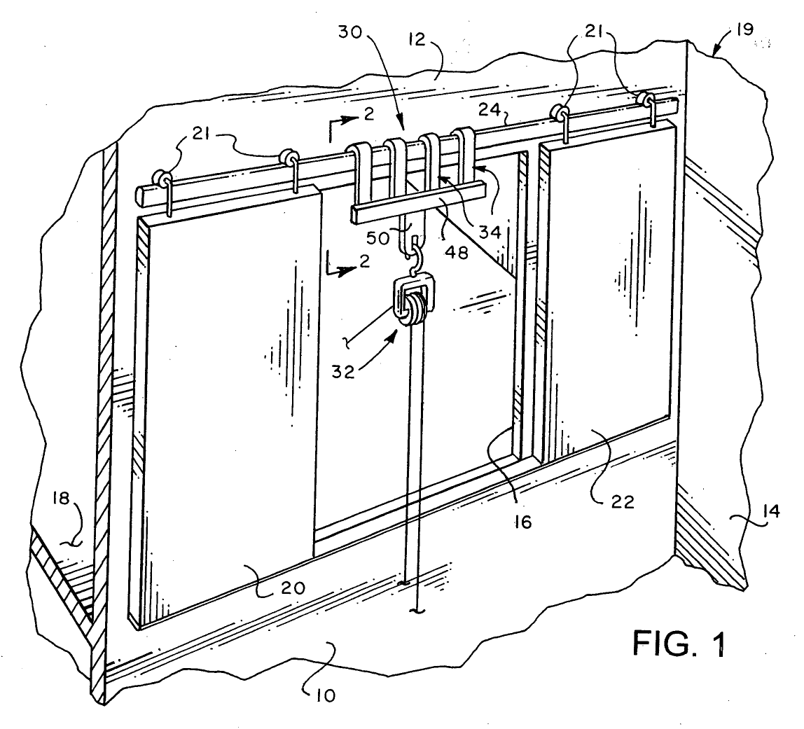

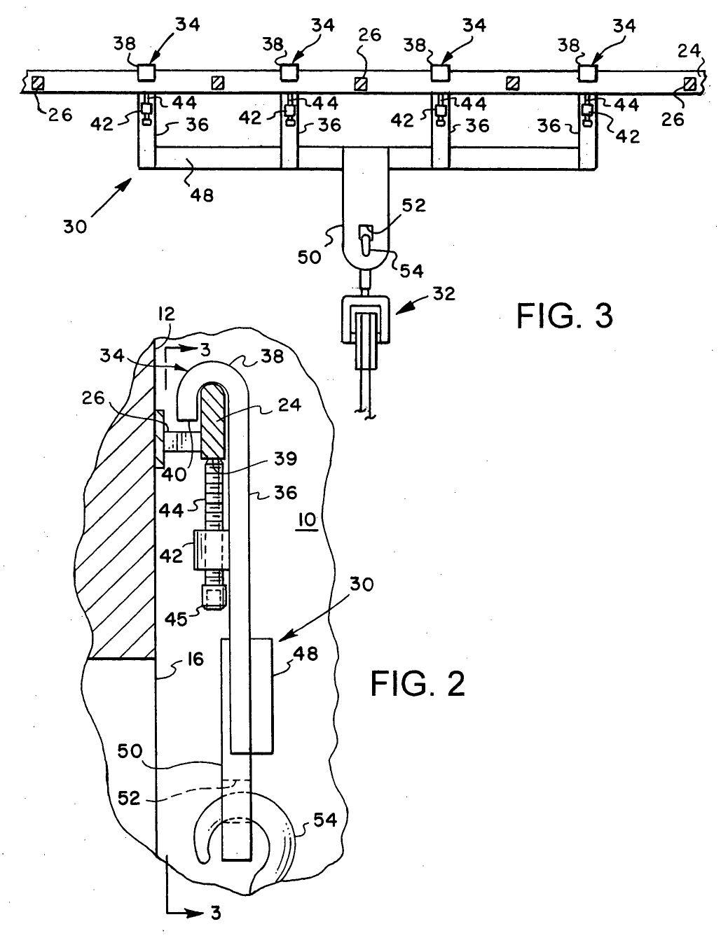

Referring to FIG. 1, there is illustrated a portion of an elevator shaft or hoistway 10 of a conventional type for housing a conventional elevator, not shown. Hoistway 10 is partially delimited by opposed intersecting walls 12 and 14. Wall 12 includes a conventional elevator doorway or opening 16 onto a floor or level 18 of a building 19 in which the hoistway 10 is disposed. Doorway or opening 16 is closable by opposed doors 20 and 22 which are mounted on or at least connected to certain support structure including, for example, an elongated support rail 24 mounted directly adjacent the wall 12 in the hoistway 10 and generally above the opening 16, as shown in FIGS. 1 and 2, for guiding and supporting the doors 20 and 22 for movement between open and closed positions. Doors 20 and 22 are shown in their open position in FIG. 1 and, by way of example, are each provided with suitable guide and support rollers 21 which engage and traverse along rail 24.

Referring also to FIG. 2, elevator door support rail 24 is shown mounted in a standoff position from the wall 12 by suitable support means which may comprise a generally flat plate elongated beam suitably mounted on structure not shown and adjacent the wall 12. The rail support means includes spaced apart members 26, see FIGS. 2 and 3, which are connected to the aforementioned beam and to the support rail 24 for supporting rail 24 in a standoff position from wall 12.

Referring further to FIG. 1, as well as FIGS. 2 and 3, there is illustrated the present invention comprising a support bracket, generally designated by the numeral 30. Support bracket 30 is adapted for supporting suitable hoisting equipment, such as a block and tackle 32 or similar apparatus for use in performing service or repair operations within the hoistway 10 and, particularly, within a bottom part of the hoistway or so called pit, not shown. Thus, equipment and persons may move between the floor 18 and the hoistway 10 through the opening 16 with the bracket 30 in the working position shown in the drawing figures to facilitate repair or service operations associated with elevator systems. Support bracket 30 is preferably characterized by plural spaced apart hook members 34, four shown by way of example. Hook members 34 each include a depending shank part 36 and a substantially arcuate upper hook part 38 configured to fit snugly over the door support rail 24, as shown in FIG. 2, in particular. The distal end 40 of hook part 38 is sufficient to snugly fit the hook part over the rail 24.

Each hook member shank 36 preferably supports a threaded boss 42 which supports an elongated sockethead machine screw 44 threadedly connected thereto and projecting upwardly and engagable with an underside surface 39 of rail 24. Upon mounting of the support bracket 30 on the rail 24 the screws 44 may be tightened to engage the rail 24 at its underside surface 39 to minimize the risk of the bracket 30 becoming disconnected from the rail 24. As shown in FIG. 3, preferably, each of the hook members 34 is provided with a boss 42 and a lockscrew 44.

Hook members 34 are each connected to an elongated transverse bracket frame member 48 extending horizontally and suitably connected to each of the hook members 34, such as by welding. The bosses 42 may also be welded to the shanks 36 of each of the book members 34, respectively. As shown in the drawing figures, support bracket 30 further includes a depending member 50 preferably centrally located between the opposite end hook members 34, and suitably connected to the member 48, such as by welding. Member 50 is also disposed, preferably, midway between opposite ends of frame member 48 and includes an opening 52 formed therein for receiving a hook 54, for example, for the block and tackle hoist 32. Those skilled in the art will recognize that the block and tackle type hoist 32 and its hook 54 are somewhat exemplary and that other types of hoisting apparatus, including simple rope or cable may be associated with the support bracket 30 and supported thereby.

The operation of the support bracket 30 is believed to be understandable to those of skill in the art based on the foregoing description. However, briefly, when the need arises to perform service or repair work in an elevator hoistway, such as the hoistway 10, the elevator car, not shown, is moved away from the floor 18 while the doors 20 and 22 are opened in a manner known to those skilled in the art to provide access between floor 18 and the hoistway 10 through the opening 16. With the doors 20 and 22 in their open position, the support bracket 30 may be placed over the support rail 24 and generally centered in the opening 16 by a person or persons standing on the floor 18 at the opening. Prior to placing the bracket 30 on the support rail 24, the screws 44 would be substantially retracted so that sufficient clearance would be provided to engage the support rail 24 with the distal hook parts 38 of the hook members 34. Upon placement of the hook members 34 on the support rail 24 the screws 44 would be snugged against the surface 39 of the support rail 24 by engaging the screw heads 45, respectively, with a suitable driving tool or wrench. The exemplary screws 44 include a socket type head 45. However, conventional hexhead screws or the like may also be used in place of the screws 44.

With the bracket 30 suitably supported on the rail 24 the hoist 32 or other suitable hoisting means may be connected to the bracket and operations utilizing the hoist 32 commenced as required.

Upon completion of the operations utilizing the support bracket 30, the screws 44 would again be retracted away from the support rail 24 and the bracket conveniently lifted off of the support rail by a person or persons standing on floor 18 at the elevator opening 16.

The support bracket 30 may be constructed of conventional engineering materials and utilizing fabrication techniques, including welding, known to those skilled in the art. By way of example, the bracket 30 may be formed of steel or aluminum plate or bar having an overall length of the member 48 of about 24.0 inches, an overall height of bracket 30 of about 8.0 inches with member 50 being formed of 0.50 inch thick plate by 4.0 inches width and 6.0 inches length. The hook members 34 and the frame member 48 may be formed of 0.38 inch by 2.0 inch flat bar stock of steel or aluminum. The hook members 34 may be spaced about 6.0 inches apart. The bosses 42 may be tapped to receive machine threads for conventional hex or socket head machine screws.

Although a preferred embodiment of an elevator hoist support bracket has been described in detail hereinabove, those skilled in the art will appreciate that various substitutions and modifications may be made to the support bracket without departing from the scope and spirit of the appended claims.

1. A support bracket for an elevator hoistway for supporting hoisting equipment for movement of persons and/or material between said hoistway and a floor serviced by an elevator disposed in said hoistway, said bracket comprising;
a first member releasably connected to support structure in said hoistway for one of supporting and guiding an elevator door: and
a second member for supporting said hoisting equipment and depending into said doorway to provide access to said hoisting equipment.

2. The support bracket set forth in claim 1 wherein:
said first member comprises a hook part for engagement with a support rail for said door.

3. The support bracket set forth in claim 2 wherein:
said first member comprises plural hook members connected to said second member for supporting said hoisting equipment.

4. The support bracket set forth in claim 2 including:
retaining means engageable with said support rail for retaining said hook part connected to said support rail during operation of said support bracket.

5. The support bracket set forth in claim 4 wherein:
said retaining means comprises a screw mounted on said first member and engagable with said support rail to retain said hook part engaged with said support rail.

6. A support bracket for mounting on a door support rail of an elevator door at a doorway between a floor of a building and a hoistway in said building, said support bracket comprising:
plural spaced apart hook members interconnected by a frame member of said support bracket, each of said hook members including a hook part engagable with said support rail; and
said frame member is adapted to support hoist equipment for movement of one of persons and material between said floor and said hoistway through said doorway when said support bracket is mounted on said support rail.

7. The support bracket set forth in claim 6 including:
a depending member connected to said frame member and including an opening formed therein for connection of said support bracket to hoist equipment.

8. The support bracket set forth in claim 6 including:
retaining means engageable with said support rail for retaining said hook members connected to said support rail during operation of said support bracket.

9. The support bracket set forth in claim 8 wherein:
said retaining means comprise screws mounted on said hook members, respectively, and engageable with said support rail to retain said support bracket engaged with said support rail.

10. A support bracket for mounting on a door support rail of an elevator door at a doorway between a floor of a building and a hoistway in said building, said support bracket comprising:
an elongated transverse frame member;
plural spaced apart hook members connected to said frame member, each of said hook members including a hook part engageable with said support rail;
a depending member connected to said frame member and including an opening formed therein for connection of said support bracket to hoist equipment; and
retaining means mounted on respective ones of said hook members and engageable with said support rail for retaining said hook members connected to said support rail during operation of said support bracket.

11. The support bracket set forth in claim 10 wherein:
said retaining means comprise machine screws mounted on said hook members, respectively, and engageable with said support rail to retain said support bracket engaged with said support rail.
